(19) United States
(12) Patent Application Publication
(10) Pub. No.: US 2026/0361189 A1
(43) Pub. Date: Nov. 12, 2026

(54) Method for Producing an Electric Lamination for a Laminated Core of an Active Part of an Electrical Machine, Electric Lamination, Active Part, and Electrical Machine

(71) Applicant: Bayerische Motoren Werke Aktiengesellschaft, Muenchen (DE)

(72) Inventor: Roland MARSTATT, Augsburg (DE)

(21) Appl. No.: 19/130,615

(22) PCT Filed: Dec. 5, 2023
(86) PCT No.: PCT/EP2023/084325

§ 371 Date: May 16, 2025

(30) Foreign Application Priority Data
Jan. 26, 2023 (DE) 10 2023 101 862.0

(51) Int. Cl. H02K 15/0278; H02K 1/04; H02K 1/276; H02K 15/027; H02K 15/035; H02K 15/12

(52) U.S. Cl. CPC H02K 15/0278; H02K 1/04; H02K 1/276; H02K 15/027; H02K 15/035; H02K 15/12

(57) ABSTRACT

A method for producing an electric lamination for a laminated core of an active part of an electrical machine, wherein, in the method, an electric lamination blank provided with an organic coating is provided, and the coated electric lamination blank is provided with blind seams in identified, critical areas which are exposed to mechanical stress during operation of the electrical machine and form leakage flux paths for magnetic leakage fluxes of a magnetic-field-generating component of the electrical machine. As a result, carbon is introduced into the electric lamination blank in these identified areas and a microstructural transformation is generated. Furthermore, a lamination, an active part and an electrical machine are specified.

### BACKGROUND AND SUMMARY

The invention relates to a method for producing an electrical lamination for a laminated core of an active component of an electric machine. The invention additionally relates to an electrical lamination, an active component and an electric machine.

Electric machines are used, for example, as drive motors for motor vehicles that can be electrically driven, such as electric or hybrid vehicles. The electric machines that are used are, for example, rotationally operating electric machines which have a first active component in the form of a fixedly mounted stator and a second active component in the form of a rotor that is mounted in a rotatable manner relative to the stator. The active component usually has laminated cores which are configured to conduct a magnetic flux of a magnetic-field-generating component, such as a coil or a permanent magnet.

The laminated cores are usually formed by a multiplicity of axially stacked magnetically conductive electrical laminations. For the best possible magnetic utilization of the electrical laminations, the magnetic permeability of the electrical laminations should be maximal. As the laminations must also be adequate for mechanical influences, leakage fluxes, i.e., undesired magnetic flux components during machine operation, cannot be avoided completely at particular points in the electrical lamination. These negatively influence the operating behavior of the electric machine, for example, the power loss increases and the torque decreases.

Commercially available electrical steel sheets, from which electrical laminations for electric motors are produced, consist of iron with a few percent silicon and are present as a coarse-grained ferritic mixed crystal. The carbon content in this case is as low as possible. The ferritic phase with large grains offers the best magnetic properties. Fine-grained ferrite or other phases would have better mechanical properties, but have poorer magnetic properties.

In the case of the construction of electric motors, there is the desire to conduct the magnetic flux inside the laminations in a targeted manner and/or to be able, by means of local regions of higher strength, to counter the centrifugal forces that are acting. High mechanical strengths and good magnetic properties are opposed to one another in this case, and this is why it is not possible to meet all desires simultaneously by means of a homogeneous material.

Against this background, it is an object of the present invention to specify an option for how electric motors can be produced in an improved manner. In particular, the previously described disadvantages should be reduced.

The object is achieved by a method for producing an electrical lamination, an electrical lamination, an active component for an electric machine and an electric machine according to the independent claims. Further advantageous embodiments emerge from the dependent claims and the following description.

A method is specified for producing an electrical lamination for a laminated core of an active component of an electric machine. In the method, an electrical lamination blank that is provided with an organic coating is provided. The coated electrical lamination blank is provided, by means of a fusion welding method, with bead on plate welds in identified critical regions which are exposed to a mechanical stress during operation of the electric machine and form leakage flux paths for magnetic leakage fluxes of a magnetic-field-generating component of the electric machine. “Bead on plate weld” is here understood to mean a weld into a material layer. The bead on plate weld is not used for connecting two or more components, but rather is used for the targeted changing of the type and the composition of the structure in that material is fused and solidifies again. During generation of the bead on plate welds, the organic coating is also fused or vaporized, as a result of which carbon passes from the material of the organic coating into the molten pool of the bead on plate weld. As a result of this, the carbon content in the lamination increases locally in the region of the bead on plate welds. In addition, due to the fusing and subsequent rapid cooling, a structural transformation to a structure with martensitic fractions is generated. Overall, a local martensitic hardening is generated, as a result of which the mechanical strength can be increased in a targeted manner in the identified critical regions.

To produce an electrical lamination, the electrical lamination blank is first provided. The electrical lamination blank is formed from an electrical steel sheet or electrical steel strip and in particular has a homogeneous magnetic conductivity or permeability. In the context of this application, “electrical steel sheet” should preferably be understood as a cold-rolled non-grain-oriented electrical steel sheet or electrical steel strip, particularly in accordance with the standards EN 10106 or EN 10303. Preferably, the electrical steel sheet has a nominal thickness of 0.25 mm. Electrical lamination blanks are produced from the electrical steel sheet, for example by punching or blanking. The electrical steel sheet is provided with an organic coating which acts as an insulator and by means of which short circuits between the electrical laminations can be avoided in the stacked state of the electrical laminations. The organic coating is applied to the electrical lamination blank on one side or preferably on both sides.

In a preferred embodiment, the organic coating is a coating of the type “EC-3” according to DIN EN 10342 (June 2005). With regard to this type of insulation, it is explained in the standard that it is an organic varnish that is applied to the surface of the steel. This coating is preferably used for final annealed non-grain-oriented electrical steel sheet and strip and punched parts produced therefrom. This coating improves the punching quality of the steel in general and is therefore very well-suited for the production of punched parts. This coating may impair suitability for welding and is not durable at the temperatures of normal stress relief annealing. The coating can be used in general at operating temperatures up to approximately 180 °C. The user should think about the problems that may arise due to the outgassing of the coating. This would apply if the steel coated in this manner were welded or exposed to elevated temperatures. Surprisingly, it has been shown that, contrary to these reservations with regard to suitability for welding especially with a coating of this type, it is possible to achieve the previously described effects (martensitic hardening with increased carbon input in the structure of the bead on plate welds).

In a further preferred embodiment, the organic coating of the type EC-3 according to DIN EN 10342 is a preferably water-dilutable epoxy-based varnish. Epoxy-based varnishes have a high proportion of carbon compounds, which is beneficial for sufficient carbonization of the bead on plate welds, as a result of which the previously described effect is achieved.

It is particularly preferred for achieving the preceding effects if, in one embodiment, the organic coating is formed as bonding varnish. An electrical lamination blank is considered as coated with bonding varnish in the context of this application in particular if the bonding-varnish layer does not fall below 1.0 μm at any location and if the total layer thickness on both sides (front and rear side of the electrical lamination blank) is 7±2 μm. The bonding-varnish layer is preferably chromate-free, RoHs-compliant and has continuous temperature resistance up to 180 °C. The bonding varnish is used both for electrically insulating the lamination and for bonding adjacent laminations during the production of the sheet-metal stack.

Exemplary varnishes which are also suitable for use as bonding varnish are available under the trade name “Remisol EB549 Rapid” from the company Rembrandtin or “Voltatex 1175W Fast” from the company Axalta.

Prior to the formation of the bead on plate welds, the regions which are exposed to the mechanical stress and the magnetic leakage fluxes during the later use of the electrical lamination in the electric machine are identified. The mechanical stress may, in the case of a rotor laminated core, result from the rotation of the rotor at high speeds. Also, the mechanical stress of the laminated cores may result from vibrations to which the electric machine, which is used as a drive motor for a motor vehicle that can be electrically driven, is exposed. The leakage fluxes—which are undesired components of the magnetic flux generated by the magnetic-field-generating component—may be superimposed with harmonics on a useful-torque-generating fundamental harmonic of a magnetic air gap flux density in the air gap and, as a result, negatively influence the torque of the electric machine. Also, additional losses are generated by the leakage fluxes in the active components. The critical regions are particularly located adjacent to accommodating regions of the electrical lamination for the magnetic-field-generating component. Such accommodating regions can for example be grooves for windings or cavities for permanent magnets.

In these regions, the targeted introduction of bead on plate welds in combination with the vaporization/fusing of the organic coating then generates a structural transformation with simultaneous input of carbon. In addition to an increase of the mechanical stability of these regions, the magnetic properties are also impaired locally in this manner and leakage fluxes are reduced as a result.

Bead on plate welds are particularly advantageous in this case, as they can be formed in a targeted manner at the desired locations. Thus, the mechanical and magnetic properties of the electrical lamination can be changed locally, that is to say only in the critical regions, without negatively influencing the non-critical regions, particularly the magnetic properties thereof.

Preferably, the bead on plate welds are formed as laser welds. For this, the material is fused by means of laser radiation. In this case, the narrow heat-affected zone and the great welding travel speeds of the laser beam that can be used have a positive effect on the material changes that can be achieved.

Furthermore, it is preferred if the bead on plate welds are formed as welded-in welds. In the case of welded-in welds, through welding does not take place and consequently no visible weld root is created. As a result of this, an organic coating formed on the rear side can be substantially or completely retained. Therefore, no renewed coating of the electrical laminations is necessary after the formation of the bead on plate welds before these electrical laminations are stacked to form the sheet-metal stack.

Furthermore, the welding is preferably carried out as an automatic welding process.

In a preferred embodiment, recesses for accommodating the magnetic-field-generating component that is formed as a permanent-magnet arrangement are separated from the electrical lamination blank and partial regions of the electrical lamination blank which adjoin the recesses are identified as the critical regions and provided with bead on plate welds. This embodiment relates in particular to an electrical lamination for a rotor laminated core of a permanent-magnet electric machine. The electrical lamination has at least two pole segments, wherein at least one recess per pole segment is arranged in the electrical lamination. The recesses are accommodating pockets for the permanent magnets, which are closed at the circumference side in particular. The recesses can be oriented tangentially and/or radially to a longitudinal axis of the electrical lamination for example. Leakage fluxes can occur particularly at edges of the permanent magnets which are arranged in the recesses. To prevent these leakage fluxes from having a negative effect on the behavior of the electric machine and contributing for example to the air gap flux density, these partial regions of the electrical lamination blank, which are adjacent to the edges of the magnets, are provided with bead on plate welds. In particular, these are also regions which are exposed to the mechanical stress during operation of the electric machine.

In each case one edge web, which is formed between a recess and an outer edge of the electrical lamination, is particularly preferably identified as a critical region and provided with at least one bead on plate weld. The edge webs are located radially between the recess and the outer edge of the electrical lamination in the case of an electrical lamination for a rotor laminated core and are loaded with a radially outwardly directed force during the rotation of the rotor. Leakage fluxes can additionally occur in particular at the edges of such an edge web, which are located at edges of the pole segment, and contribute to the air gap flux density in an undesired manner. To prevent this, the edge webs are provided with at least one bead on plate weld.

It may also be provided that in each case two recesses are separated from the electrical lamination blank in a V shape, wherein a central web that is formed between the recesses is identified as a critical region. In particular, at least two recesses per pole segment are arranged in a V-shaped manner. The lamination therefore has two recesses arranged in a V-shaped manner in each case, wherein a central web formed between the recesses is identified as a critical region and provided with at least one bead on plate weld. For example, the recesses can be oriented tangentially relative to the axis of rotation, that is to say be arranged horizontally to one another. Here, the angle of the V arrangement is 180 °for example. Also, the V arrangement of the magnets can have an angle of less than 180 °. The central web is formed between the recesses. In the case of the horizontal V arrangement with an angle of 180 °, the central web and therefore the critical region have a rectangular shape. In the case of the V arrangement with an angle of less than 180 °, the central web and therefore the critical region have a wedge-like or triangular shape. This central web is provided at least to some extent with one or more bead on plate welds.

Furthermore, an electrical lamination is specified for a laminated core of an active component of an electric machine, which is produced by a method according to the claims.

Furthermore, an active component for an electric machine is specified with a laminated core with a multiplicity of axially stacked, previously described, electrical laminations and a magnetic-field-generating component, which is held by the laminated core. The active component is in particular designed as a rotor for a permanent-magnet electric machine and the magnetic-field-generating component is an embedded permanent magnet arrangement.

Furthermore, an electric machine is specified having at least one active component according to the invention. The electric machine is preferably used as a drive motor for an electrically intolerable motor vehicle. The electric machine can be an asynchronous machine (ASM) or a synchronous machine. The synchronous machine can for example be a permanent-magnet synchronous machine (PSM) or an externally or current excited synchronous machine (SSM). The electric machine can be manufactured in an internal rotor design or external rotor design.

Features and details that are described in connection with the method for producing an electrical lamination also apply in connection with the electrical lamination, the active component and the electric machine and vice versa in each case, so with respect to the disclosure, reference is or can always be made reciprocally to the individual aspects of the invention.

Further advantages, features and details of the invention emerge from the following description in which exemplary embodiments of the invention are described in detail with reference to the drawings.

In this case, the features mentioned in the claims and in the description may be essential to the invention in each case individually separately or in any desired combination. If the term “can” is used in this application, it relates both to the technical possibility and the actual technical implementation.

In the following, exemplary embodiments are explained with reference to the attached figures. In the figures, in schematic illustration:

### BRIEF DESCRIPTION OF THE DRAWINGS

FIGS. 1 and 2 show method steps for producing an exemplary electrical lamination,

FIG. 3 shows a sectional view through a bead on plate weld of the electrical lamination from FIG. 2, and

FIG. 4 shows an alternative electrical lamination which is produced using the method according to the invention.

### DETAILED DESCRIPTION OF THE DRAWINGS

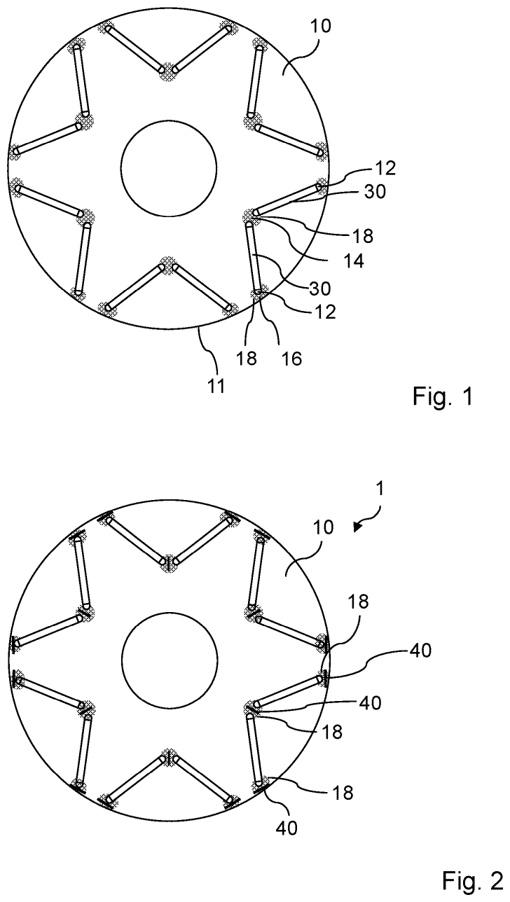

FIG. 1 shows an electrical lamination blank 10 which, following further processing to form electrical lamination 1 (FIG. 2), can be stacked with further electrical laminations 1 to form a laminated core of an active component of an electric machine. The electrical lamination blank 10 shown here is provided by way of example for an active component in the form of a rotor of a permanent-magnet internal-rotor machine. The electrical lamination blank 10 is formed from a magnetically conductive material and coated with an insulator in the form of an organic coating 20 (see FIG. 2). The electrical lamination blank 10 can be formed by punching out of an electrical steel sheet.

The electrical lamination blank 10 has a plurality of recesses 12 which are formed as punched out regions in the electrical lamination blank 10 and are designed to accommodate a magnetic-field-generating component 30. By way of example, the magnetic-field-generating component 30 is formed as a permanent magnet arrangement. The recesses 12 are arranged in a V-shaped manner here. A central web 14 is formed between the recesses 12. Edge webs 16 are formed between the recesses 12 and the outer edge 11 of the electrical lamination 10. The electric machine is a 6-pole design. For reasons of clarity, the features are only labeled for one pole, but also apply just the same for the further poles.

Here, both the central web 14 and the edge webs 16 form critical regions 18 (illustrated as stippled areas) of the electrical lamination 10, as they are exposed to a mechanical stress during operation of the electric machine and also form leakage flux paths for magnetic leakage fluxes which are caused by the magnetic-field-generating component 30. In order to increase the mechanical strength or stability in the critical regions 18 and simultaneously to disrupt the leakage flux paths by reducing the magnetic conductivity of the electrical lamination blank 10 in the regions 18, at least one bead on plate weld 40 is formed in each case in the identified critical regions 18.

FIG. 2 shows the electrical lamination 1 resulting from the electrical lamination blank 10 with bead on plate welds 40 formed in the identified critical regions 18. The bead on plate welds 40 are illustrated as straight lines here for reasons of clarity. They are not limited to this form however and can also be realized with a curved shape, as a weave weld or in any other form that is expedient for achieving the desired effect. In particular, individual bead on plate welds 40 can differ from one another.

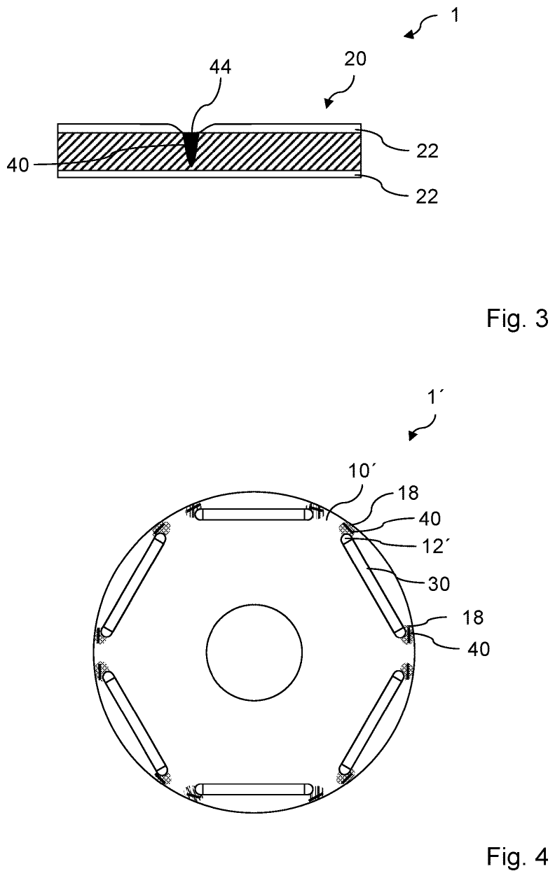

The electrical lamination blank is provided with an organic coating 20; see FIG. 3. This coating is preferably realized by the type EC-3 according to DIN EN 10342. Preferably, the electrical lamination blank 10 is provided with one coat 22 of the organic coating 20 in each case on both sides, as shown in FIG. 3. The organic coating 20 is preferably formed as bonding varnish, wherein each layer 22 has a thickness of at least 1 μm and preferably at least 3 μm or more or particularly preferably 4 μm or more. FIG. 2 shows a sectional view of an exemplary bead on plate weld 40 in the electrical lamination 1. The bead on plate weld 40 is welded from one side of the electrical lamination 1 into the same, preferably by means of laser radiation. The bead on plate weld 40 is preferably configured as welding in, as a result of which the organic coating facing the weld root 42 is retained. On the upper side of the weld 44, the organic coating 20 is melted and vaporized due to the energy input during the welding process. Here, carbon of the organic coating 20 has been introduced into the molten material of the bead on plate weld 40. As a result, the lamination 1 has undergone a structural change in the region of the bead on plate weld 40 and has an increased carbon content compared to the rest of the lamination 1. The result of this is that the region 18 processed with the bead on plate weld 40 then has an increased mechanical strength and a reduced magnetic conductivity.

FIG. 4 shows a further electrical lamination 1′ which is produced using the method according to the invention. The electrical lamination blank 10′ used for this differs from the electrical lamination blank 10 described for FIGS. 1 and 2 only in that the shape and arrangement of the recesses 12 for accommodating the magnetic-field-generating component are realized differently. Accordingly, the critical regions 18 in this exemplary embodiment are in each case located in edge webs 16 between the outer edge 11 of the electrical lamination 1 and the recesses 12. The bead on plate welds 40 are formed in the identified critical regions 18.

### LIST OF REFERENCE SIGNS

1 Electrical lamination
10 Electrical lamination blank
11 Outer edge
12 Recesses
14 Central webs
16 Edge webs
18 Critical regions
20 Organic coating
22 Layer
30 Magnetic-field-generating component
40 Bead on plate welds
42 Weld root
44 Upper side of the weld

1.-13. (canceled)

14. A method for producing an electrical lamination for a laminated core of an active component of an electric machine, the method comprising:
coating an electrical lamination blank with an organic coating;
welding the coated electrical lamination blank with bead on plate welds in identified critical regions which are exposed to a mechanical stress during operation of the electric machine and form leakage flux paths for magnetic leakage fluxes of a magnetic-field-generating component of the electric machine; and
generating carbon input into the electrical lamination blank and a structural transformation in the identified critical regions.

15. The method according to claim 14, wherein the organic coating is a coating of type EC-3 according to DIN EN 10342.

16. The method according to claim 15, wherein the organic coating is formed by an epoxy-based varnish.

17. The method according to claim 14, wherein the bead on plate welds are formed as laser welds.

18. The method according to claim 15, wherein the bead on plate welds are formed as laser welds.

19. The method according to claim 14, wherein the bead on plate welds are formed as welded-in welds.

20. The method according to claim 15, wherein the bead on plate welds are formed as welded-in welds.

21. The method according to claim 14, wherein the welding is carried out as an automatic welding process.

22. The method according to claim 15, wherein the welding is carried out as an automatic welding process.

23. The method according to claim 14, wherein recesses for accommodating the magnetic-field-generating component that is formed as a permanent-magnet arrangement are separated from the electrical lamination blank, and partial regions of the electrical lamination blank which adjoin the recesses are identified as the identified critical regions and provided with the bead on plate welds.

24. The method according to claim 15, wherein recesses for accommodating the magnetic-field-generating component that is formed as a permanent-magnet arrangement are separated from the electrical lamination blank, and partial regions of the electrical lamination blank which adjoin the recesses are identified as the identified critical regions and provided with the bead on plate welds.

25. The method according to claim 23, wherein in each case one edge web, which is formed between a recess and an outer edge of the electrical lamination blank, is identified as a first identified critical region and provided with at least one of the bead on plate welds.

26. The method according to claim 24, wherein in each case one edge web, which is formed between a recess and an outer edge of the electrical lamination blank, is identified as a first identified critical region and provided with at least one of the bead on plate welds.

27. The method according to claim 23, wherein in each case at least two recesses are separated from the electrical lamination blank in a V shape, wherein a central web that is formed between the at least two recesses that are arranged in the V shape is identified as a first identified critical region and provided with at least one of the bead on plate welds.

28. The method according to claim 24, wherein in each case at least two recesses are separated from the electrical lamination blank in a V shape, wherein a central web that is formed between the at least two recesses that are arranged in the V shape is identified as a first identified critical region and provided with at least one of the bead on plate welds.

29. An electrical lamination for a laminated core of an active component of an electric machine, which is produced by a method according to claim 14.

30. An active component for an electric machine having a laminated core with a plurality of axially stacked electrical laminations according to claim 29 and a magnetic-field-generating component, which is held by the laminated core.

31. The active component according to claim 30, wherein the active component is configured as a rotor for a permanent-magnet electric machine and the magnetic-field-generating component is an embedded permanent magnet arrangement.

32. An electric machine for a motor vehicle having at least one active component according to claim 30.

33. An electric machine for a motor vehicle having at least one active component according to claim 31.
